(19) United States
(12) Patent Application Publication
(10) Pub. No.: US 2014/0100944 A1
(43) Pub. Date: Apr. 10, 2014

(54) METHOD AND SYSTEM FOR ONLINE CAMPAIGN OPTIMIZATION

(71) Applicant: SHARE THIS INC., Palo Alto, CA (US)

(72) Inventors: Changyi Zhu, San Jose, CA (US); Markku Salkola, Palo Alto, CA (US); Xibin Chen, Cambell, CA (US); Souvik Ray, Cupertino, CA (US); Prasanta Behera, Cupertino, CA (US); Nanda Kishore, Los Altos, CA (US)

(73) Assignee: SHARE THIS INC., Palo Alto, CA (US)

(21) Appl. No.: 13/647,638

(22) Filed: Oct. 9, 2012

(51) Int. Cl. G06Q 30/02

(52) U.S. Cl. 705/14.41; 705/14.49; 705/14.71

(57) ABSTRACT

An advertisement campaign optimization system, method, and a computer product for determining real time bidding data corresponding to one or more advertisement campaigns targeting one or more users are disclosed. In an embodiment, the method comprises receiving a bid request for the one or more advertisement campaigns. User interest data corresponding to the one or more users is determined. One or more bidding rules based on a first data set and a second data set are also determined. The first data set comprises data corresponding to the one or more users and the second data set comprises data corresponding to the one or more advertisement campaigns. The method determines real time bidding data based on the user interest data and the one or more bidding rules.

### TECHNICAL FIELD

The presently disclosed embodiments generally relate to advertisement campaign optimization. More particularly, the presently disclosed embodiments relate to systems and methods for determining an optimized real time bidding data for advertisement campaigns.

### BACKGROUND

A real time bidding system is used for analyzing, bidding, and selecting online advertisements based on user data and advertisement data. The user data and the advertisement data collectively correspond to real time bidding data associated with the advertisement campaign. The real time bidding system then facilitates advertising servers to place the selected online advertisement across one or more domain web servers that are owned by web publishers. An optimized real time bidding data helps the web publishers and the advertising servers in determining a maximized return for investment (ROI) of the advertisement campaign.

### SUMMARY

According to the embodiments illustrated herein, there is provided a system, a method, and a computer implemented method for determining real time bidding data corresponding to one or more advertisement campaigns targeting one or more users. In an embodiment, the method comprises receiving a bid request for the one or more advertisement campaigns. User interest data corresponding to one or more users is determined. One or more bidding rules based on a first data set and a second data set are also determined. The first data set comprises data corresponding to the one or more users and the second data set comprises data corresponding to the one or more advertisement campaigns. The method determines real time bidding data based on the user interest data and the one or more bidding rules.

### BRIEF DESCRIPTION OF DRAWINGS

The accompanying drawings, which are incorporated in and constitute a part of the application, illustrate various example systems, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples, one element may be designed as multiple elements or that multiple elements may be designed as one element. In some examples, an element shown as an internal component of another element may be implemented as an external component and vice versa. Furthermore, elements may not be drawn to scale.

Various embodiments will hereinafter be described in accordance with the accompanying figures provided to illustrate and not limit the scope in any manner, wherein like references indicate similar elements.

FIG. 1 is a real time bidding (RTB) system environment diagram in accordance with some embodiments;

FIG. 2 is a block diagram of an RTB server in accordance with some embodiments;

FIG. 3 is a flowchart for generating real time bidding data in accordance with some embodiments; and

FIG. 4 is a report generated by a display engine in accordance with some embodiments.

### DETAILED DESCRIPTION

The present disclosure is best understood with reference to the detailed figures and description set forth herein. Various embodiments are discussed below with reference to the figures. However, those ordinarily skilled in the art will readily appreciate that the detailed description given herein with respect to these figures is just for explanatory purposes as the method and the system extend beyond the described embodiments. In an illustrative example, those ordinarily skilled in the art will appreciate, in light of the teachings presented, recognizing multiple alternate and suitable approaches, depending on the needs of a particular application, to implement the functionality of any detail described herein beyond the particular implementation choices in the following embodiments described and shown.

References to “one embodiment”, “some embodiments”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in some embodiments” does not necessarily refer to the same embodiment, though it may.

### DEFINITION OF TERMS

Advertisement campaign: An advertisement campaign is a sequence of advertisement messages based on a product or a service that are delivered to one or more users through the Internet and World Wide Web. Examples of advertisement campaigns may include, but are not limited to, contextual advertisements on web pages, banner advertisements, blogs, rich media advertisements, social network advertisements, online classified advertisements, and advertisements via e-mail marketing, including e-mail spam and/or the like.

Advertisement campaign descriptors: Advertisement campaign descriptors correspond to information/description related to an advertisement campaign. The advertisement campaign descriptors may include, but are not limited to, a plurality of keywords associated with the advertisement campaign, details about users visiting the advertisement campaign but not converting into customers, user's behavioral response descriptors, a social optimization pixel or retargeting pixel on a web page hosted by an advertising server, and at least one content category associated with the advertisement campaign. The advertisement campaign descriptors may also include, but are not limited to, the name of the advertisement campaign, an audience segment targeted by the advertisement campaign, viewer names, advertisement impressions, clickers, number of visits corresponding to each viewer, and/or the like.

Advertisement data: Advertisement data may include, but are not limited to, creatives, impressions, advertisement inventory, channels, timelines, budgets, and other information, including historical information, relating to use and distribution of advertisements. The advertisement data may also include advertisement campaign descriptors. The advertisement data may also include an identifier for the user e.g. a cookie, the web page content category, time, price paid, advertisement message shown, and resulting user actions or behavior, or some other type of advertisement campaign and heuristic logs. The advertisement data may also include business statistical data, which may describe dynamic and/or static marketing objectives, or may describe the operation of the advertising server.

Advertisement Conversion: An advertisement conversion happens when the user performs an action on an advertiser's website after viewing an advertisement. The advertisement conversion may include, but is not limited to, clickthrough, viewthrough, browsethrough, game conversion, and/or the like.

Advertising server: An advertising server is a web based platform that holds the inventory of the advertisement campaigns. The advertising server, after winning a real time bid, places one or more advertisement campaigns in an ad space of the web pages of a website corresponding to a domain web server. The advertising server may also provide software(s) to websites to serve advertisement campaigns, count the ad impressions of the advertisement campaigns, and choose the best advertisement campaign that provides the website and the advertising server maximum revenue. The advertising server further manages, monitors and evaluates progress of different advertisement campaigns.

Ad space: An ad space is a space on a web page reserved for displaying the advertisement campaigns. Generally, the ad space is located at the top, bottom, right, or left column of the web page. The location depends on the size of the advertisement campaign to be displayed.

Ad impression: An ad impression (herein referred to as “impression”) refers to a count of exposures a user has to an advertisement campaign. For example, if an advertisement campaign is viewed by 1,000 users over the course of a day, it could be said that the advertisement campaign enjoyed 1,000 impressions, as each user viewed goods or services advertised therein. The impression is counted in different ways depending upon format of the ad space situated on the web page, as well as the number of times the web page is shown where the advertisement appears. Number of impressions corresponding to the advertisement campaign is tracked by a tracking component to judge whether the advertisement campaign is working or not. Programs like Web Trends read the log, abstract meaning from it, and generate a report about the web page usage. Other programs, such as Central Ad, can keep track of all impressions that have been sent and how many of these were clicked on by the users.

Audience Segment: An audience segment corresponds to a class or group of an audience. An advertisement campaign finely tuned to an audience segment offers better results, a higher response rate, and a higher conversion rate. Targeting the advertisements to an appropriate audience segment not only enhances the visitation but increases the conversion rates many times.

Exchange network: An exchange network is a web based platform designed for buying and selling advertisement campaigns and impressions. The exchange network may include information related to attributes of an advertisement campaign such as cost of advertisement impression, number of advertising servers in a specific product or services category, historic data about the highest and the lowest bid for a definite period, advertisement success (when a user clicks the advertisement impression), and/or the like. The advertising servers use the information as part of decision-making and financial transactions.

Key Performance Indicator (KPI): KPIs include, but are not limited to, estimate of cost per 1000 views of the ad (CPM), effective receiving by a publisher in response to advertising inventory sold by an advertiser on a cost per mille (eCPM), ratio of number of times an advertisement is clicked divided by number of times the advertisement is viewed (CTR), percentage of leads generated via paid search (PPC), getting visitors to do a target action, percentage of visitors to a website that engage in a target action (Conversion Rate), percentage of visitors who viewed product pages (Prospect Rate), percentage of visitors who abandoned one or more pages (Abandonment Rate), percentage of visitors who stick around and read the website (Committed Visitor Index), one or more pages designed for new arrivals to switch them from scanning to reading (Landing Pages), percentage of visitors who merely scan a website then leave (Total Bounce Rate), conversion rate for visitors coming from each advertisement multiplied by the cost per visitor (Cost Per Acquisition or CPA). KPIs also include number of impressions multiplied by cost per impression (Advertising spent).

Log Record: Log records are metadata that are received from a tracking component located on a web page. The log record is indicative of one or more activities of the plurality of users on the plurality of web pages. The log record may include, but is not limited to, an anonymous cookie representing one or more of the plurality of users, a click log, a sharing log, a timestamp, an event type, a sharing channel, a content identifier, a universal resource locator (URL), domain information, and a browsing pattern of each of the plurality of users.

Log Data: The log data correspond to a data structure configured to store a plurality of log records corresponding to the plurality of users.

Publisher: A publisher corresponds to a group, organization, company, or an individual responsible for originating a production of or maintaining a website. A publisher's revenue comprises advertising revenue paid for by the advertising servers in exchange for placements of their advertisement campaigns on the publisher's website. Publishers may be compensated in different ways, including, but not limited to, flat rate fees, cost per click, cost per 1,000 impressions, cost per conversion, etc. One publisher can own a single or multiple domain web servers or websites. Domain web servers, comprising a plurality of web pages, provide a location to place advertisement campaigns by an advertising server to be viewed by a user visiting the website.

Social optimizing pixel: A social optimizing pixel corresponds to a tracking component that is served on a web page of an advertisement campaign. The social optimizing pixel records metadata corresponding to a user visiting the web page.

Retargeting pixel: A retargeting pixel corresponds to a tracking component that is served on a web page of an advertisement campaign for collecting metadata of a user visiting the web page. Thereafter, when the user visits other web sites, the user is presented with the advertisement campaign to bring back the user to the web page. The user may be targeted with the advertisement campaign again in future based on the metadata collected using the retargeting pixel.

Tracking application: A tracking application corresponds to a software application installed in a web server as an embedded tracking component in a web page hosted by the web server.

Tracking component: A tracking component is a web-based component that is part of a web page configured to gather/collect log records. The log records facilitate tracking of a user activity. The tracking component captures online activity of a user on the web page. Examples of the tracking component may include, but are not limited to, a widget, a button, a social optimizing pixel, a retargeting pixel, a hypertext, an HTML tag, and a link on each of the plurality of web pages corresponding to the plurality of domain owners. Tracking component can be used to track advertisement impressions, user visits, click-through rates, interaction, or purchases from Web sites of an advertising server as a result of users clicking on sponsored links associated with the advertising server.

User Activity: A user activity corresponds to activities performed by the user on a plurality of web pages. User activity is also referred to as an event. Examples of user activities include, but are not limited to, sharing through a tracking component, viewing a web page, clicking a web link, visiting a web page or searching for a keyword. The user activities are usually stored as user activity data that has users represented as cookies.

User Interest data: User interest data may be inferred from online activities performed by the user on a web page. For example, interests of a user may be determined from a content category of a web page (e.g., news, sports, music, stock market, cartoons etc.) on which one or a plurality of online activities are performed.

User Features: User features comprise a plurality of attributes associated with the user. The user features may be one of, but not limited to, content category associated with the at least one web page, keywords representing the user's interest, share keywords, share response keywords, search keywords or total number of visits of the user to the at least one web page. User features facilitate segment formation based on a similarity index.

Web Page: A web page is an online document or information resource that is suitable for the World Wide Web and can be accessed through a browser and displayed on a monitor of a computing device or a mobile phone.

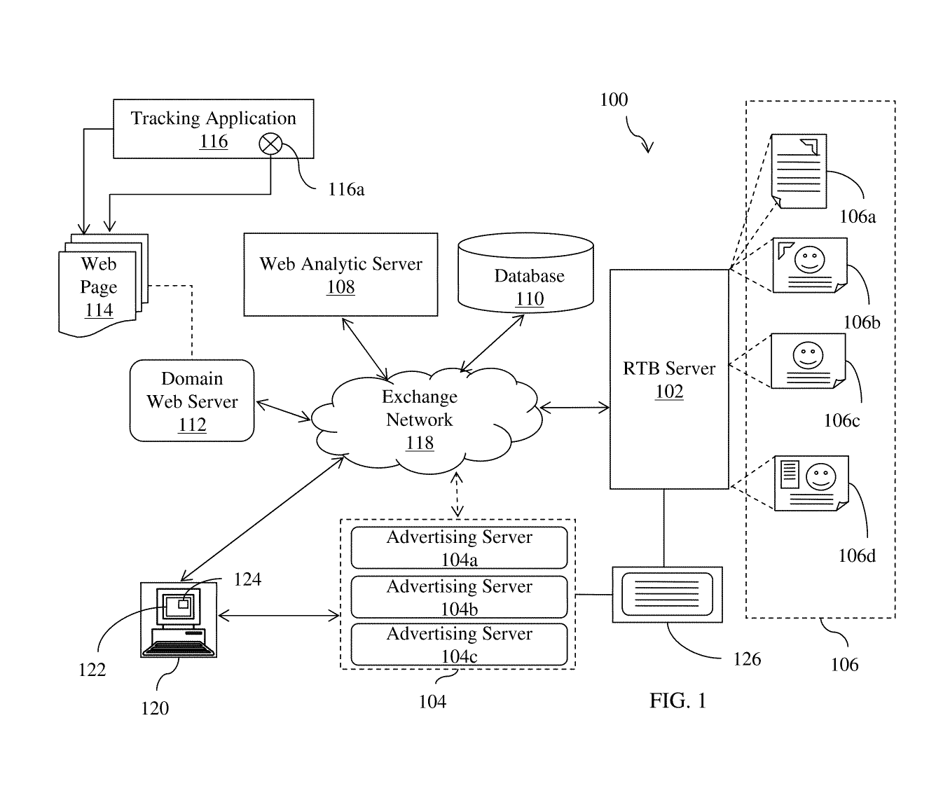

FIG. 1 illustrates a real time bidding (RTB) system environment 100 in which the present disclosure is implemented. The RTB system environment 100 includes a real time bidding (RTB) server 102, and a plurality of advertising servers 104a, 104b, and 104c, hereinafter referred to as an advertising server 104, participating in real time bidding. A plurality of advertisement campaigns 106a, 106b, 106c, and 106d, hereinafter referred to as an advertisement campaign 106, are provided to the RTB server 102 for bidding. The RTB system environment 100 further includes a web analytic server 108, a database 110, and one or more domain web servers such as domain web server 112. The RTB system environment 100 further includes a plurality of web pages 114, hereinafter referred to as a web page 114, hosted by the domain web server 112, and a tracking application 116. The tracking application 116 when installed in the domain web server 112 results in an embedded tracking component 116a in the web page 114 hosted by the domain web server 112. Further, the RTB system environment 100 includes an exchange network 118 and a computing device 120 comprising a browser 122. The web page 114 when loaded in the browser 122 raises an ad request to the domain web server 112 for serving one of the plurality of advertisement campaign 106a, 106b, 106c, and 106d in an ad space 124 of the web page 114. The RTB system environment 100 also includes an advertisement campaign dashboard 126 that may display a real time bidding data along with advertisement campaign related data generated by the RTB server 102. In an embodiment, the advertisement campaign dashboard 126 may be implemented in the RTB server 102 and/or the advertising server 104.

The RTB server 102 is a functional unit that participates in the real time bidding and assists the advertising server 104 in determining real time bidding data corresponding to the advertisement campaign 106. In some embodiments, the real time bidding data includes pricing (for example, starting bidding price, minimum bidding price, and maximum bidding price) and delivery speed of the advertisement campaign 106. In an embodiment, the ad request generated corresponding to the ad space 124 is received by the exchange network 118. The exchange network 118 determines a bid request corresponding to the ad request and forwards the bid request to the RTB server 102. The RTB server 102 receives the bid request, determines an optimized real time bidding data, and generates a bid response comprising the optimized real time bidding data. The bid request is preferably generated individually for each advertising server of the plurality of advertising servers 104a, 104b, and 104c.

In light of the teachings presented in the present disclosure, those ordinarily skilled in the art will appreciate and recognize multiple alternatives for associating the RTB server 102 with the advertising server 104. In some embodiments, the RTB server 102 may be associated with the plurality of advertising servers 104a, 104b, and 104c, either individually or in a group, depending on the needs of a particular application. In some embodiments, the association may correspond to the RTB server 102 being a part of at least one of the plurality of advertising servers 104a, 104b, and 104c. The association implements the functionality of the RTB server 102 described herein, beyond the particular implementation choices in the following embodiments described and shown.

The RTB server 102 may be a general-purpose computer, a programmed microprocessor, a micro-controller, a peripheral integrated circuit element, and other devices or arrangements of devices that are capable of implementing steps that constitute the methods of the present disclosure. Examples of the RTB server 102 may include, but are not limited to, Apache HTTP Server®, Microsoft Internet Information Services (IIS)®, and Sun Java System Web Server®.

The advertising server 104 corresponds to a platform that serves the advertisement campaign 106 to the ad space 124 on the web page 114. The advertising server 104 is a fully functional internet advertising management and serving system. In an embodiment, the advertising server 104 is a group of advertising server 104a, advertising server 104b, and advertising server 104c participating in a real time bidding, and competing for the ad space 124 on the web page 114. During a real time bidding cycle, the advertising server 104 in conjunction with the RTB server 102 generates bids for advertisement campaign 106. The advertising server 104 wins the real time bidding for the advertisement campaign 106 based on one or more optimized real time bidding data. Specifically, the advertisement campaign 106a and the advertisement campaign 106b correspond to the advertising server 104a in this embodiment. The advertisement campaign 106c and the advertisement campaign 106d correspond to the advertising server 104b and the advertising server 104c respectively. The advertisement campaign 106 that wins the real time bidding is then allotted to the ad space 124 on the web page 114.

The advertisement campaign 106 corresponds to a planned series of advertisements for advertising a product or service. The advertisement campaign is aimed at a particular target market or an audience segment over a defined period of time for increasing sales or raising awareness of the product or service. In various embodiments, the advertisement campaign 106 generates revenue based on one or more of Cost Per Mille metric (CPM) or Cost Per Thousand Impressions (CPT), Cost Per Click metric (CPC), and Cost Per Action or Cost Per Acquisition metric (CPA). Other metrics may include, but are not limited to, Cost Per Visitor, Cost Per View, Cost Per Lead, Cost Per Sale, Effective CPM, Fixed Cost, Cost Per Conversion, and/or the like.

The web analytic server 108 corresponds to a web analytic system capable of extracting and analyzing data for commercial purposes by using a plurality of analytic tools. The analytical tools may include, but are not limited to, a tracking tool, a social behavior analytic tool, a target audience analytic tool, audience segmentation tool, user modeling tool, campaign analytics tools, and campaign optimization tool. Further, the web analytic server 108 may extract data using various languages, such as Structured Query Language (SQL), 4D Query Language, Object Query Language, and Stack Based Query Language (SBQL). Typical examples of a web analytic server 108 include a general-purpose computer, a programmed microprocessor, a micro-controller, a peripheral integrated circuit element, and other devices or arrangements of devices that are capable of implementing steps that constitute the method of the present disclosure.

The database 110 corresponds to a storage device that stores data required to uncover relationships between the users, the user activities, the user behavior, the publishers, the advertising server 104, and the advertisement campaign 106 in a networked environment during real time bidding. For example, the database 110 can store information associated with a plurality of users, tracking data, user interest data, advertisement data, and publisher data. In some embodiments, the database 110 may include data that is generated by the web analytic server 108 and used by the RTB server 102, for example, the user interest data. In an embodiment, the database 110 may be a structured collection of records. Each record may be an advertisement object having a list of tags that may characterize the advertisement campaign 106. The database 110 can be implemented by using several technologies that are well known to those skilled in the art. Some examples of technologies include, but are not limited to, MySQL® and Microsoft SQL®, Hive, Hbase, and/or the like.

The domain web server 112 corresponds to a web based platform capable of storing information corresponding to owners of the domain web server 112 and publishers that own the domain web server 112. Examples of the owners of the domain web server 112 include, but are not limited to, Facebook®, LinkedIn®, Stumble Upon®, and Constantcontact®. In an embodiment, the domain web server 112 subscribes to the web analytic server 108 for one or more web analytics services. Such web analytic services may include share quality index analysis for domain ranking, social graph construction, social lookalike, influencer modeling, audience analytics, content analysis, and path to conversion analysis.

The web page 114 frequently includes resources such as style sheets, scripts, and images that are made into a final presentation. In some embodiments, the web page 114 is scripted either from a computing device 120 (e.g. client-side scripting) or from a domain web server 112 (e.g. server-side scripting). Client-side scripting (e.g. on the computing device 120) may be implemented in JavaScript that permits an access to information and functions available on the user's browser 122. Server-side scripting (e.g. on the domain web server 112) helps in generating dynamic web pages. Languages used for server-side scripting may include, but are not limited to, Perl, PHP, ASP.NET, Java, and server-side VBScript, and/or the like.

The tracking application 116 corresponds to a software module installed in the domain web server 112. The installation results in an embedded tracking component 116a in the web page 114 hosted by the domain web server 112.

In some embodiments, tags are inserted in the web page 114 of the domain web server 112 for tracking and collection of a plurality of advertisement campaign performance descriptors. In some embodiments, the advertising server 104 appropriately and automatically tags the web page 114 added to the web site of the domain web server 112. In some embodiments, tagging includes placing a universal tag on the web pages in the header. The universal tag consists of code used to capture any user specific information associated with the web page 114 tracked by the tracking component 116a. The universal tag also identifies and gathers a plurality of statistics for the web page 114 in which it has been embedded.

Preferably, each of the plurality of web pages, e.g. the web page 114, is associated with the tracking application 116. The domain web server 112 allows the tracking application 116 to download one or more tracking components, e.g. the tracking component 116a from the web and install the tracking component 116a in the web page 114.

The exchange network 118 corresponds to a platform that brings publishers and advertising server 104 together on a marketplace for participating in real time bidding for the ad space 124. The exchange network 118 corresponds to a medium through which content and messages flow between the various components (e.g. the computing device 120, the RTB server 102, the advertising server 104a, the advertising server 104b, the advertising server 104c, the web analytic server 108, the database 110, the domain web server 112, and the computing device 120) of the RTB system environment 100 during real time bidding.

Examples of the exchange network 118 may include, but are not limited to, AdECN®, Right Media®, ContextWeb's Exchange®, DoubleClick®, QZedia®, Ayha Exchange®, Adbrite®, and Zinc Exchange®.

The exchange network 118 may be implemented as, but is not limited to, a television broadcasting system, an IPTV network, a Wide Area Network (WAN), a Local Area Network (LAN), a Metropolitan Area Network (MAN), or a Wireless Fidelity (Wi-Fi) network.

Various devices in the RTB system environment 100 can connect to the exchange network 118 in accordance with various wired and wireless communication protocols such as Transmission Control Protocol and Internet Protocol (TCP/IP), User Datagram Protocol (UDP), and 2G, 3G, or 4G communication protocols. The exchange network 118 may implement a plurality of algorithms which allow the domain web server 112 to evaluate advertisement impressions during the real time bidding.

The computing device 120 corresponds to a user receiving the advertisement campaign 106 on the web page 114 from the advertising server 104 that has won the real time bidding. In embodiments, the computing device 120 may be a mobile device, a PDA, cell phone, a computer, a communicator, a digital device, a digital display panel or some other type of device able to present advertisements.

The computing device 120 includes one or more browsing applications that enable the user to browse through one or more web pages, (e.g. the web page 114). While the user browsers through a web page, the browser 122 send a request for an advertisement for the ad space 124 in the web page 114. In an embodiment, the RTB server 102 facilitates real time bidding based on pricing and delivery speed of one of the advertisement campaign 106 (e.g. 106a, 106b, 106c, or 106d). A highest bidding advertisement campaign (e.g. 106a, 106b, 106c, or 106d) is selected. Thereafter, the browser 122 fetches the selected advertisement from the advertising server 104 (one of the advertising servers 104a, 104b, and 104c). Although one computing device 120 has been shown in FIG. 1, it may be appreciated that the disclosed embodiments can be implemented with a large number of computing devices.

The advertisement campaign dashboard 126 is a user interface coupled to the RTB server 102 for displaying metadata about the impressions of the advertisement campaign 106, status of the advertising server 104, reporting, user accounts, budgets, real time bidding data, and/or the like. In some embodiments, the advertising server 104 tracks the number of impressions of the advertisement campaign 106 being implemented on the advertising server 104 and accommodates pricing flexibility based on volume. The pricing may be automatically controlled by the advertising server 104 according to certain volume levels and may be adjusted by an operator of the advertising server 104 through the advertisement campaign dashboard 126. In some embodiments, the advertisement campaign dashboard 126 also provides a listing of the impressions associated with the advertising server 104. The advertisement campaign dashboard 126 may indicate the status of the impressions of the advertisement campaign 106 in real time or with updates at defined instants.

In some embodiments, the advertisement campaign dashboard 126 allows for on-line viewing of impressions, minimum bids, starting bids, maximum bids, existing bids, amounts, and conditions that must be bid to win the rights by the advertising server 104 to serve the ad space 124.

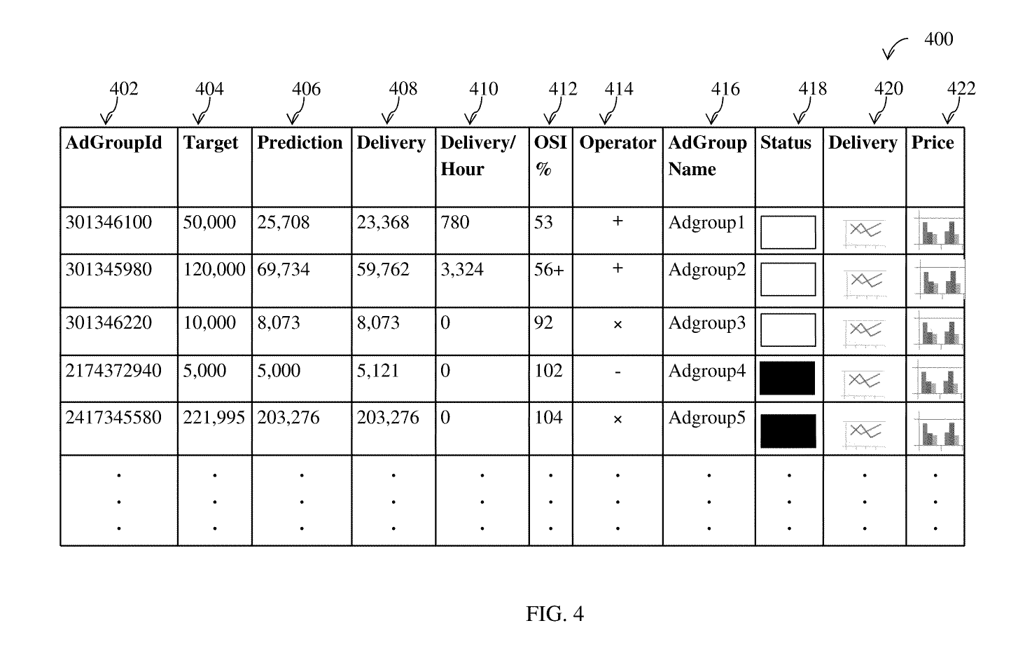

In some embodiments, the advertisement campaign dashboard 126 facilitates the advertising server 104 to perform adding impressions corresponding to a new advertisement campaign, impressions corresponding to an edited advertisement campaign, impressions corresponding to a newly launched advertisement campaign, or impressions corresponding to an advertisement campaign that is currently running. The advertisement campaign dashboard 126, as described herein, may enable displaying sales and status of real time bidding when the advertisement campaign is not meeting objectives. In some embodiments, notifications may be sent for the advertisement campaign 106. The notifications may include, but are not limited to, beginning-of-campaign, end-of-campaign, daily-over-delivery, daily-under-delivery, lifetime-under-delivery, lifetime-over-delivery, weekly & monthly campaign reports, end of campaign reports, or some other types of notification. An exemplary advertisement campaign dashboard report is described in more detail with reference to FIG. 4. The advertisement campaign dashboard 126 may be implemented on a mobile device, a PDA, cell phone, a computer, a communicator, a digital device, a digital display panel, or some other type of devices able to present advertisement campaigns.

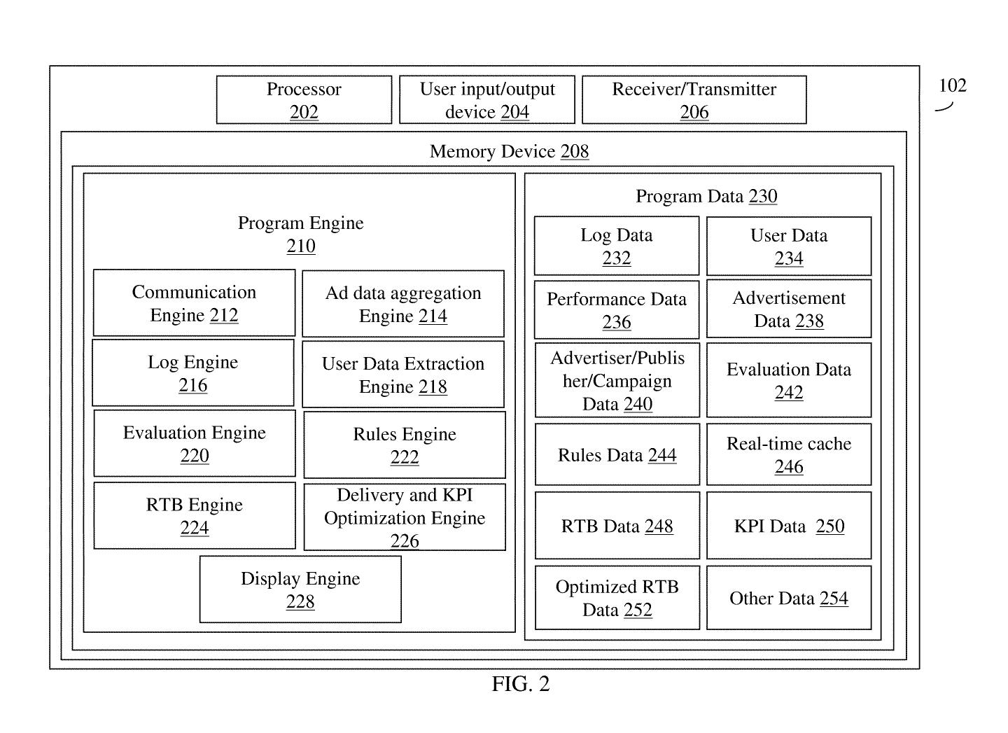

FIG. 2 is a block diagram of the RTB server 102 in accordance with some embodiments. Accordingly, the RTB server 102 includes a processor 202, a user input/output device 204, a receiver/transmitter 206, and a memory device 208.

The processor 202 can be realized through a number of processor technologies known in the art. Examples of the processor 202 include, but are not limited to, X86 processor, RISC processor, ASIC processor, CSIC processor, or any other processor. It will be appreciated that the processor 202 could be readily constructed to execute control programs. The control programs may be executed by a virtual machine hosted by the RTB server 102. In some embodiments, the control programs are in byte-code format, which facilitates interoperability across heterogeneous platforms.

The receiver/transmitter 206 acts as an interface for receiving the bid requests and transmitting the bid responses from and to the exchange network 118.

The memory device 208 is configured to store the program engine 210 and program data 230. The program engine 210 is configured to utilize the program data 230 for implementing various embodiments. Examples of the memory device 208 include, but are not limited to, floppy disks, magnetic tapes, punched cards, hard disk drives, optical disc drives, and USB flash drives.

The program engine 210 stores a set of instructions or modules. The set of instructions or modules includes a communication engine 212, an evaluation engine 220, a log engine 216, a user data extraction engine 218, an ad data aggregation engine 214, a rules engine 222, an RTB engine 224, a delivery and KPI optimization engine 226, and a display engine 228.

For the purpose of illustration, all the engines in the program engine 210 are a part of a single RTB server 102. However, a person ordinarily skilled in the art would appreciate that one or more of program engine 210 can be implemented in separate computing systems forming a system working together for carrying out the functionality of the invention without departing from the scope of the invention.

The one or more program engine(s) 210 access the program data 230 for retrieving data and variables for processing.

In some embodiments, the program data 230 stores data required to uncover the relationship between the RTB server 102, the advertising server 104, the advertisement campaign 106, the database 110, the domain web server 112, the computing device 120, and/or the like in the RTB system environment 100. In an illustrative example, the program data 230 stores log data 232, user data 234, performance data 236, advertisement data 238, advertiser/publisher/campaign data 240, evaluation data 242, rules data 244, real-time cache 246, RTB data 248, KPI data 250, optimized RTB data 252, and other data 254.

The program data 230 can be implemented by using several technologies that are well known to those skilled in the art. Some examples of technologies include, but are not limited to, MySQL® and Microsoft SQL®.

The log data 232 is generated as a result of one or more online activities performed by the user on the web page 114 in the browser 122. In some embodiments, the one or more online activities comprise sharing through a tracking component 116a, viewing the web page 114, clicking a web link on the web page 114, or searching for a keyword in the browser 122. In some embodiments, the log data 232 may store bid requests and bid responses handled by the RTB server 102. In some embodiments, the log data 232 includes details about the tracking component 116a that are inserted in the web page 114 for tracking the user activity in the browser 122.

The user data 234 correspond to a data structure configured to store a plurality of metadata corresponding to the users, for example user features and user interests. The user data 234 includes details of the one or more online activities performed by preferably each of a plurality of users on web page 114. In an embodiment, for example, the web analytic server 108 processes and analyzes the metadata corresponding to the users and stores it in the database 110. The user data 234 preferably includes at least a part of the data stored in the database 110. In some embodiments, the user data 234 includes user interest data that is determined from a content category of the web page 114 (e.g., news, sports, music, stock market, cartoons etc.) on which the one or more online activities are performed. In some embodiments, the user data 234 may include additional data related to the plurality of users, such as details of the websites that the plurality of users has visited or may visit in the future. The details are used to derive user interests or browsing habits of the plurality of users.

In some embodiments, the user data 234 includes metadata corresponding to the user operating the computing device 120. The metadata includes, but is not limited to, time, date, user ID, user cookie, Internet Protocol address of the computing device 120, the user's history, demographic details, geographic location, transaction data, user conversion data, or some other type of data related to the user. In some embodiments, the user data 234 further includes ad impressions viewed by the user, user clicks, user conversions, and other user actions performed on the advertisement campaign 106. In some embodiments, the user data 234 stores mappings between users and user behavior towards the advertisement campaign 106 or their visits and conversions on web sites of the advertising server 104. In some embodiments, the user data 234 may correspond to offline or online data.

The performance data 236 corresponds to a data structure that is intended to store advertisement performance data, user's performance on advertisement impressions, user behavior data including clicks and conversions, advertisement campaign performance descriptors, KPI metrics, and a plurality of statistics according to the various embodiments.

In some embodiments, the performance data 236 comprises data identifying how well the advertisement campaign is performing based on one or more KPI metrics. The KPI metrics may include, for example, number of times an advertisement has been served i.e. ad impressions, number of times the advertisement has been selected (e.g., a click-through rate), number of conversions that have been recorded, the average revenue associated with the ad impressions, survey information about the advertisement from those viewers that have received the advertisement, or predicted performance scores for each participation in a bid, among others.

The performance data 236 is coupled to the log engine 216 and stores a part of log data 232. In some embodiments, the advertisement campaign performance descriptors and other information is periodically or continually updated in the performance data 236 as new or updated information is obtained. Accordingly, a periodic (e.g. hourly, daily, weekly, monthly, quarterly or yearly) performance model is generated according to an embodiment.

The advertisement data 238 corresponds to a data structure configured to store a plurality of attributes associated with the advertising server 104 and the advertisement campaign 106. In some embodiments, the advertisement data 238 stores a plurality of advertisement campaign descriptors associated with the advertisement campaign 106. In some embodiments, advertisement data 238 also stores an inventory of ad impressions corresponding to the advertisement campaign 106.

The advertiser/publisher/campaign data 240 refers to a data structure that stores one or more parameters corresponding to the advertising server 104, publisher of the domain web server 112, and the advertisement campaign 106. The one or more parameters may include, but are not limited to, pricings, advertisement product creation, vendor management descriptors, and/or the like. In some embodiments, the advertiser/publisher/campaign data 240 facilitates sale, input, service, targeting, reporting, and delivery of advertisement campaigns in online advertising.

In some embodiments, the advertiser/publisher/campaign data 240 includes advertisement operational data that facilitates advertisement scheduling, advertisement coordinating, advertisement campaign managing, advertisement trafficking, billing personnel, inventory management, yield management, vendor management, and technical operations thereof.

The evaluation data 242 can include a data structure that stores data to predict an economic value of the impression (e.g., the cost required per impression), and the amount of volume (e.g., the number of impressions) purchased at each price. In some embodiments, the RTB server 102 constructs a price-volume curve to determine the bid price needed to purchase a desired volume of ad inventory within a daily budget for the advertising servers. The valuation and volume data is collected by the evaluation engine 220. The evaluation data 242 is significant as the advertising server 104 bids at different bid prices.

The rules data 244 is configured to store one or more bidding rules and the user interest data to determine real time bidding data. The one or more bidding rules comprise one or more of a condition based rule, a limitation based rule, a decision based rule and a customized rule based on the real time bidding data. The customized rule may be a user-defined bidding rule based on the real time bidding data. In some embodiments, the one or more bidding rules generated by the rules engine 222 and stored in the rules data 244 may be structured to incentivize the advertising server 104 participating in the agreement to report initial pricings. The initial pricings are based on a shared metric tied to a value of actions that may result from allocations. The rules data 244 may further include allocation rules, payment rules, and/or the like.

In some embodiments, the allocation rules correspond to how the exchange network 118 allocates the ad space 124 at each cycle in which the ad space 124 becomes available. The ad space 124 is allocated to the advertising server 104 having the highest value of one or more metrics. For example, a higher initial valuation of an advertisement campaign increases an advertising server's likelihood of winning an allocation.

In some embodiments, the payment rules may specify that for each allocation, the exchange network 118 computes a payment amount to be charged to the advertising server 104 that allocates the ad space 124. The payment amount may be computed based on an initial valuation of the advertising server 104, such that reporting a higher initial valuation reduces the payment amount of the advertising server 104 upon allocation. In some embodiments, the exchange network 118 may also compute the payment amount based on updated value reports and/or statistical data.

The real-time cache 246 is a small but high-speed data structure configured to store a part of log data 232 and a part of the evaluation data 242 required by the RTB engine 224. The log data 232 and the evaluation data 242, as explained in more detail with reference to FIG. 4, allows the delivery and KPI optimization engine 226 to determine an optimized real time bidding data.

The RTB data 248 corresponds to a data structure configured to store a plurality of real time details of one or more bid requests and responses corresponding to the ad space 124 in the web page 114. In some embodiments, the RTB data 248 may record rate of arrival of advertising space opportunities from different advertisement channels.

The KPI data 250 corresponds to a data structure comprising one or more key performance indicators of the one or more users (for example the user associated with the computing device 120) and the advertisement campaign 106 for optimizing the RTB data 248 generated by the RTB engine 224.

The optimized RTB data 252 stores an optimized RTB data as determined by the delivery and KPI optimization engine 226.

The other data 254 is configured to store temporary and miscellaneous data required for the program engine 210 according to various embodiments.

The communication engine 212 receives a bid request from the exchange network 118 and stores it in the log data 232. The RTB engine 224 responds by dynamically generating an optimized real time bidding data. The communication engine 212 communicates the bid response back to the exchange network 118 based on a time constraint. The bid response preferably occurs simultaneous with or very near in time to the bid request receipt.

The ad data aggregation engine 214 determines a plurality of advertisement campaign descriptors from the advertisement data 238, the advertiser/publisher/campaign data 240, and the evaluation data 242. The advertisement campaign descriptors are stored in the advertisement data 238. In some embodiments, the advertisement campaign descriptors correspond to one or more of an online or an offline advertisement based data.

The log engine 216 corresponds to a functional unit that is coupled to the browser 122 of the computing device 120. In some embodiments, the log engine 216 is further associated with the performance data 236. In some embodiments, the tracking component 116a performs automatic tracking of advertisement performance or user behavior information and stores the result in the performance data 236.

In an embodiment, the log engine 216 tracks and stores advertisement performance data, advertisement impressions, user behavior data including clicks and conversions, advertisement campaign performance descriptors, KPI metrics and a plurality of statistics according to the various embodiments in the performance data 236. In some embodiments, the log engine 216 predicts an advertisement performance of one or more advertisements and user behavior of a plurality of users performing online activities on each of the one or more ad impressions. The log engine 216 is coupled to the performance data 236. The log engine 216 can send performance tracking data to the performance data 236. In some embodiments, the log engine 216 stores a part of log data in the real-time cache 246.

In some embodiments, the log engine 216, by using the tracking component 116a, may associate the social optimization pixel or the retargeting pixel to all the advertisement campaigns 106 residing in the advertising server 104. Once the social optimization pixel or the retargeting pixel is served from the log engine 216, the social optimization pixel or the retargeting pixel may record the metadata corresponding to the user operating the computing device 120. The log engine 216 stores the metadata in the log data 232. In some embodiments, the log engine also records ad impressions, user clicks, user conversions, and other user actions, and stores them in the user data 234.

In some embodiments, the advertisement campaign 106 is selected from the advertising server 104 based on the highest bid. The advertisement campaign 106 selected may then be associated with the tracking component 116a and sent to the ad space 124 in the web page 114. The tracking component 116a may then be tracked, and future impressions, clickthroughs, conversions, and/or the like are recorded in the log data 232 by the log engine 216.

The user data extraction engine 218 is configured to extract the metadata corresponding to the plurality of users, the user features, and the user interests from the database 110 and store a local copy in the user data 234. In an embodiment, the user data extraction engine 218 may extract a part of the performance data 236 and store it in the other data 254. In some embodiments, the user data extraction engine 218 is further configured to facilitate an extraction of different types of data from one or more external databases (e.g. the database 110) and store it in the user data 234. In one embodiment, the user interest data is analyzed and processed by the web analytic server 108 and stored in the database 110. An example of the web analytic server 108 is ShareThis®.

In some embodiments, the evaluation engine 220 is configured to determine an economic valuation data of the bids dynamically for the advertisement campaign 106. The economic valuation data determines bid pricings in relation to the economic valuations for a plurality of ad spaces (e.g. the ad space 124). In some embodiments, real time bidding for the ad space 124 and/or advertisement campaign 106 is based on the economic valuations. In some embodiments, the evaluation engine 220 helps the RTB engine 224 in selecting one of the advertisement campaigns 106 with the highest economic value.

In some embodiments, the evaluation engine 220 includes statistics information usable in forecasting the network traffic, traffic volume of users having defined characteristics, and associated advertising information. In some embodiments, the evaluation engine 220 stores a part of valuation data in the real-time cache 246.

In some embodiments, the evaluation engine 220 collects valuation information of the ad space 124 in the web page 114 of the browser 122 using the tracking component 116a.

In some embodiments, the evaluation engine 220 updates the advertising server 104 with the bidding values of the advertisement campaign 106 for the ad space 124 automatically or otherwise. More specifically, the evaluation engine 220 helps in adjusting the bid values of the advertisement campaign 106 in a most optimal way, which increases the likelihood of winning the bid by the advertising server 104 (e.g. the advertising server 104b).

In some embodiments, the evaluation engine 220 may further periodically and/or dynamically forecast information comprising a number of future ad spaces or impressions, actual contract information and a prediction of future contracts. The evaluation engine 220 may further process the forecasted information for determining an advertising plan for the advertisement campaign 106.

In some embodiments, the evaluation engine 220 may include any number of pricing, delivery, forecasting, and optimization processes or procedures implemented as software or hardware, or a combination thereof.

The rules engine 222 generates one or more bidding rules based on which the RTB engine 224 generates the real time bidding data. The one or more bidding rules are stored in the rules data 244 by the rules engine 222. In some embodiments, the rules engine 222 creates the one or more bidding rules based on the advertisement campaigns 106 that are performing well for a given user, and may optimize the content of the advertisement campaign 106 based on the created one or more bidding rules. The RTB engine 224 uses the output of the rules engine 222 to generate the real time bidding data that conforms to the one or more bidding rules created by the rules engine 222.

The rules engine 222 includes one or more machine learning algorithms. A person of ordinary skill in the art would appreciate any suitable combination of some, none, or all of known machine learning algorithms could be used depending on a desired level of complexity and/or the details of the particular application at hand.

Examples of machine learning algorithms may include, but are not limited to, Naive Bayes, Logistic Regression, Neural Networks, Bayes Net, Support Vector Machines, and Decision Trees. The algorithms may return what specific advertising is most likely to produce an action or which characteristics describe advertisings most likely to produce an action. These characteristics can include advertisings concept, advertisings size, advertisings color, advertisement text, or any other characteristic of an advertisement, web site concept, products presented, colors, images, prices, text, or any other characteristic of the website.

In some embodiments, the rules engine 222 includes one or more optimizing algorithms for optimizing the one or more machine learning algorithms based at least in part on new interactions (or lack thereof) between a selected advertisement campaign and the user associated with the computing device 120.

In some embodiments, the one or more bidding rules may further include, but are not limited to, profit margin maximization bidding rules, inventory level minimization bidding rules, excessive inventory reduction bidding rules, inventory seasonality/perishability bidding rules, sales trend analyzing bidding rules, past online advertising, marketing campaign analysis bidding rules such as bidding rules which analyze past ROIs of previous campaigns, and/or the like. Such bidding rules are well-known to one of ordinary skill in the art, and it will be appreciated that any suitable combination of some, none, or all of these rules could be used depending on a desired level of performance and/or the details of the particular application at hand.

The RTB engine 224 is configured to generate an optimum real time bidding data for the ad space 124 based on the user interest data from the user data 234 and the one or more bidding rules from the rules data 244. In some embodiments, the RTB engine 224 determines real time bidding data associated with the users and the advertisements from the real-time cache 246. In some embodiments, the RTB engine 224 generates bid values for the advertisement campaign 106 corresponding to the advertising server 104. The bid values may be used to determine an average bid value corresponding to at least one of the advertisement campaigns 106 required to be located to the ad space 124 on the web page 114 in the browser 122. For example, referring back to FIG. 1, the advertising server 104a comprises the advertisement campaign 106a and the advertisement campaign 106b bidding an amount of $0.50 cost per thousand page impressions (CPM) and 2.50 CPM respectively. Similarly, the advertising server 104b and the advertising server 104c bid their respective advertisement campaign 106c and advertisement campaign 106d at bid values of $1.00 CPM and $1.50 CPM, respectively, on the exchange network 118.

In an embodiment, selection of highly optimized advertisement campaign 106b (corresponding to the advertising server 104a) by the exchange network 118 is based on the real time bidding data, for example pricing and delivery speed. While in this example the advertising server 104 bid their advertisement campaign 106 in terms of cost per thousand page impressions (“CPM”), one of ordinary skill recognizes different types of bids such as, for example, cost per click (“CPC”), cost per action (“CPA”), and/or the like.

In some embodiments, the RTB engine 224 checks with the advertising server 104 whether the corresponding advertisement campaign 106 has enough inventory and budget to participate in the real time bidding, and places the advertisement campaign 106 in the advertisement data 238.

The RTB engine 224 includes one or more software or hardware modules to perform machine learning techniques, and substantial computations, including numerous arithmetic calculations and logic operations. In some embodiments, the RTB engine 224 includes notice, selection, and decision functions for generating real time bidding data. The RTB engine 224 receives a notification or a bid request about the ad space 124 on the web page 114 through the exchange network 118.

The delivery and KPI optimization engine 226 is configured to minimize the advertising spent in relation to one or more predetermined campaign performance goals. For each of the advertisement campaigns 106, the delivery and KPI optimization engine 226 evaluates a plurality of data from the program data 230 (such as the log data 232, the user data 234, the advertisement data 238, the advertiser/publisher/campaign data 240, the evaluation data 242, and the RTB data 248). For at least one of the plurality of the RTB data 248 and. the ad space 124, one or more advertisement campaigns 106 (e.g. the advertisement campaign 106a, the advertisement campaign 106b, the advertisement campaign 106c, or the advertisement campaign 106d), may be selected and presented to the domain web server 112 based at least in part on the optimized advertising spent and given campaign goals. In an embodiment, the delivery and KPI optimization engine 226 comprises one or more machine learning algorithms trained on the user data 234, the rules data 244, the real-time cache 246, and the other data 254. The one or more machine learning algorithms generates an optimized real time bidding data and stores it in the optimized RTB data 252.

In some embodiments, the one or more machine learning algorithms in the delivery and KPI optimization engine 226 may also use a training dataset derived from a previous advertisement campaign stored in the other data 254. The training dataset may include a record of prior impressions, conversions, actions, click-throughs and/or the like performed by the computing device 120 on past advertisements corresponding to a prior advertisement campaign. The delivery and KPI optimization engine 226 identifies a subset of advertising content from the prior advertisement campaign that was relatively more successful than other advertisement campaigns. In some embodiments, the delivery and KPI optimization engine 226 recommends the advertising content for future use on the basis of its higher bid value. The delivery and KPI optimization engine 226 stores the bid value and related data in the RTB data 248.

In some embodiments, the advertisement campaign 106 may be specifically pulled as part of or attached to the web page 114 requested by the browser 122, or pushed over the exchange network 118 by, for example, the delivery and KPI optimization engine 226.

In embodiments, the delivery and KPI optimization engine 226 delivers contents of the evaluation data 242 of an advertisement to a consumer of the evaluation data 242, such as the advertising server 104, an advertising agency, an advertiser, an ad network, an ad exchange, a publisher, or some other types of consumer.

In some embodiments, the delivery and KPI optimization engine 226 may be coupled to the tracking application 116 of the web page 114. In some embodiments, the delivery and KPI optimization engine 226 may be coupled to the browser 122 of the computing device 120.

In some embodiments, valuation, bid amounts (including starting bidding price, minimum bidding price and maximum bidding price), and/or the like may be optimized by the delivery and KPI optimization engine 226 based on the key performance indicators from the KPI data 250.

The display engine 228 collects, aggregates, and displays a part of contents of the user data 234, the RTB data 248, the rules data 244, the KPI data 250, the log data 232, the advertisement data 238, the performance data 236, the advertiser/publisher/campaign data 240, and/or the other data 254 on the advertisement campaign dashboard 126. An exemplary report corresponding to the advertisement campaign dashboard 126 is illustrated in FIG. 4 as explained later on.

The RTB engine 224, the rules engine 222, the delivery and KPI optimization engine 226, the log engine 216, and the evaluation engine 220 may be collectively or individually physically embodied on or in a non-transitory computer-readable medium. This computer-readable medium may include CD-ROM, DVD, tape, cassette, floppy disk, memory card, and large-capacity disk. This computer-readable medium, or media, could be distributed to end-users, licensees, and assignees. These types of computer-readable media and other types not mention here but considered within the scope of the present disclosure, allow the RTB server 102 to be easily disseminated. A computer program product for selecting a structure for real time bidding includes the RTB server 102 stored on the computer-readable medium. The RTB server 102 may also be physically embodied on or in any addressable (e.g., HTTP, I.E.E.E. 802.11, Wireless Application Protocol (WAP)) wireline or wireless device capable of presenting an IP address. Examples could include a computer, a wireless personal digital assistant (PDA), an Internet Protocol mobile phone, or a wireless pager.

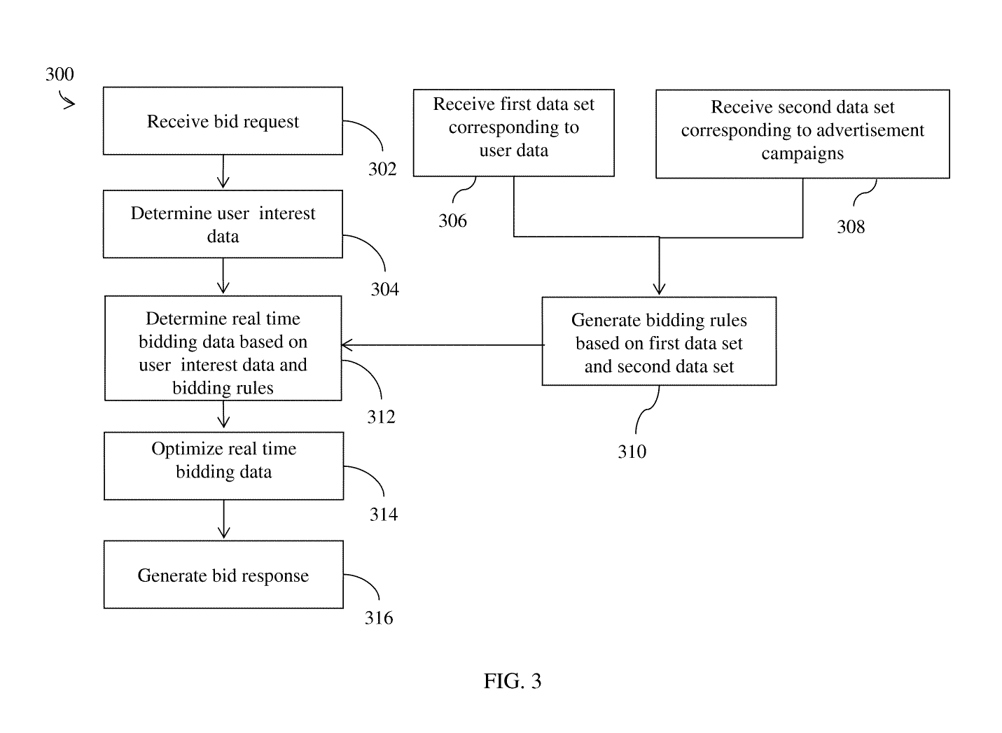

FIG. 3 is a flowchart 300 for generating an optimized real time bidding data in accordance with some embodiments. FIG. 3 will be explained in conjunction with FIG. 1 and FIG. 2.

At method step 302, the receiver/transmitter 206 receives a bid request from the exchange network 118 and transmits the bid request to the communication engine 212. The communication engine 212 logs the bid request in the log data 232. In some embodiments, the communication engine 212 analyzes the bid request for one or more metadata corresponding to the ad space 124, the browser 122, or a user of the computing device 120. The communication engine 212 stores the metadata corresponding to the user in the user data 234.

In some embodiments, the bid request corresponds to an ad request raised by the browser 122. The ad request is raised as a result of loading the web page 114 comprising the ad space 124. In an embodiment, the exchange network 118 captures the ad request through the domain web server 112 and determines a bid request corresponding to the ad request.

In some embodiments, the communication engine 212 verifies whether the bid request is eligible for further processing or not. The communication engine 212 verifies that the advertisement campaign 106 residing in the advertising server 104 must be compatible with the ad space 124. For example, the size of the ad space 124 must coincide with the size of the advertisement campaign 106. The domain web server 112 may further limit the type of the advertisement campaign 106, such as specifying that the advertisement campaign 106 can't be in a particular file format. In some embodiments, the eligibility may further be based on a competitive exclusion or rules of the exchange network 118. In some embodiments, one or more modules of the exchange network 118 determine eligibility of the bid request.

At the method step 304, the user data extraction engine 218 refers to the bid request in the log data 232 and extracts user interest data in an embodiment. The user data extraction engine 218 extracts the user interest data from some specific servers (e.g. SHARETHIS®) that are dedicated for mining user interests, performing analytics and generating statistics and reports for one or more users including the user corresponding to the computing device 120. The user interest data is stored in the user data 234 by the user data extraction engine 218.

At the method step 306, the user data extraction engine 218, in some embodiments, further aggregates data from a plurality of program data 230, for example, the user data 234, the log data 232, and the performance data 236, and generates a first data set. The user data extraction engine 218 stores the first data set in the user data 234. In some embodiments, the first data set corresponds to one or more of an online or an offline user data.

At the method step 308, the ad data aggregation engine 214 refers to the advertisement data 238, the advertiser/publisher/campaign data 240, and the evaluation data 242 to generate a second data set. The second data set comprises a plurality of advertisement campaign descriptors and gets stored in the advertisement data 238. In some embodiments, the second data set corresponds to one or more of an online or an offline advertisement based data.

At the method step 310, the rules engine 222 extracts the first data set and the second data set from the user data 234 and the advertisement data 238 respectively and generates bidding rules. The rules engine stores the bidding rules in the rules data 244. In some embodiments, the rules engine 222 receives real time performance data of the user corresponding to at least one of the plurality of advertisement campaign 106 directly from the RTB engine 102. In some embodiments, the rules engine 222 extracts online log data directly from the log engine 216. In some embodiments, the rules engine 222 extracts offline log data from the log data 232 being updated on a periodic basis. The periodic intervals may vary from hourly to daily basis.

In some embodiments, the rules engine 222 may use one or more algorithms to order and prioritize the algorithms based at least in part on the performance of each algorithm. The algorithms in the rules engine 222 generates one or more bidding rules corresponding to one or more of a condition based rule, a limitation based rule, a decision based rule and a customized rule based on the real time bidding data. A rule based on one or more real time bidding data may correspond to delivery rules, performance rules, allocation rules and pricing rules.

At the method step 312, in some embodiments, real time bidding data is determined based on the user data 234, the rules data 244, and the real-time cache 246, and stored in the RTB data 248 by the RTB engine 224. In some embodiments, the RTB engine 224 determines the user interest data from the user data 234.

In some embodiments, the RTB engine 224 comprises one or more deterministic algorithms to compute a starting bidding price, minimum bidding price, maximum bidding price and delivery speed of the advertisement campaign 106 at a configurable time interval. In some embodiments, the RTB engine 224 provides a set of application programming interfaces (APIs) to allow the rules engine 222 to poll its bidding status in real time.

At the method step 314, the real time bidding data stored in the RTB data 248 is optimized by the delivery and KPI optimization engine 226 based on the one or more KPIs and stored in the optimized RTB data 252. The one or more KPIs are determined from the KPI data 250 by the delivery and KPI optimization engine 226.

In some embodiments, the delivery and KPI optimization engine 226 optimizes delivery of the ad impression of the advertisement campaign 106 over one or more audience segments. The delivery and KPI optimization engine 226 takes into account long time scale variations and patterns in the advertisement campaign dynamics. The time scales may be, for example, a month, a week, a day, or several hours. In some other embodiments, the delivery and KPI optimization engine 226 optimizes the real time bidding data that fluctuate on shorter time scales, for example, seconds or minutes. In some other embodiments, the delivery and KPI optimization engine 226 targets an audience segment from the user data 234 whose intrinsic conversion ratios are above the average conversion ratios. The one or more audience segments are determined from the user data 234.

At step 316, the RTB engine 224 generates a bid response in response to the bid request based on the optimized RTB data 252. The bid response is utilized to select an advertisement campaign from the advertisement campaign 106. The RTB engine 224 saves the bid response in the log data. The communication engine 212 determines the bid response from the log data 232 and transmits the bid response to the exchange network 118 via the receiver/transmitter 206. The bid response comprises the real time bidding data that comprises at least one of bidding price and delivery instructions for the advertisement campaign 106.

In some embodiments, the bid response comprises one or more of a monetary bid amount, advertisement campaign descriptors, advertisement metadata, accounting information, pricing details, delivery speed, and/or other statistical data. In some embodiments, the bid response may be excluded and not considered for various reasons such as invalidity, incompleteness, lateness, and/or irrelevance.

In some embodiments, the real time bidding data in the form of a bid response is transmitted to the exchange network 118 through an application programming interface of the RTB server 102. The exchange network 118 collects one or more bid responses corresponding to the advertisement campaign 106, and selects an optimum bid response from the one or more bid responses. Finally, one of the pluralities of the advertisement campaign 106, for example the advertisement campaign 106b, corresponding to the optimum bid response is selected from the advertising server 104a by the exchange network 118.

The advertising server 104 serves the advertisement campaign 106 to the ad space 124 on the web page 114 in the browser 122 of the computing device 120. Serving the advertisement campaign 106 typically involves placing the advertisement campaign 106 in the ad space 124 of the web page 114 of the domain web server 112. The advertisement campaign 106 is presented to a user of the browser 122 visiting the publisher's web page 114, for instance. Optionally, additional operations or functions may be performed, such as, for example, compensation of the appropriate entities, logging activity, traffic management, and the like.

FIG. 4 is an exemplary report 400 generated by the display engine 228 in accordance with some embodiments. The exemplary report 400 includes a column 402 labeled “AdGroupId” that stores a numeric identification of the group of the advertisement campaign 106 (e.g. 301346100, 301345980, 301346220 etc.). A column 404 labeled “Target” stores a numeric value corresponding to a daily impression target. Next is column 406 labeled “Prediction” containing numeric values corresponding to a prediction of economic value of the impression of the advertisement campaign. Column 408 labeled “Delivery” includes numeric values corresponding to delivery impressions. A column 410 labeled “Delivery/Hour” is the same as the column 408 except for the fact that in the column 410, the impressions delivered are recorded on an hourly basis. A column 412 labeled “OSI %” corresponds to a numeric value indicating daily delivery of impressions. The column 412 indicates whether the impression is ahead of or behind schedule by comparing the average number of impressions delivered each day with the optimal daily delivery. A column 414 labeled “Operator” includes operators like +, −, × etc., corresponding to an adjustment factor of pricing of the impressions based on volume level. A column 416 labeled “AdGroupName” includes the name of the adgroup of advertisement campaigns (for example, Adgroup1, Adgroup2, Adgroup3, Adgroup4, and Adgroup5). The column 418 labeled “Status” included colored flags depicting the delivery of the adgroup against a target (for example white color, black color in the exemplary report 400). Column 420 and column 422 labeled as “Delivery” and “Price” respectively corresponds to pictorial representations of the real time bidding data generated by the RTB server 102. The column “Delivery” correspond to the delivery speed of the adgroup, and the column “Price” correspond to a price-volume curve of the adgroup. The bidding price further segregated as starting bidding price, minimum bidding price and maximum bidding price.

The method of the invention may be carried out by a computer system. The computer system according to an embodiment comprises a computer, an input device, and a display unit. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be other similar means for loading computer programs or other instructions into the computer system. The computer system may also include a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through an input device accessible to the system through an I/O interface. The computer system executes a set of instructions that are stored in one or more non-transitory storage elements in order to process input data. The storage elements may also hold data or other information as desired. The storage element may be in the form of an information source or a physical memory element present in the processing machine.

The programmable or computer readable instructions may include various commands that instruct the processing machine to perform specific tasks, such as the steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to ‘C’, ‘C++’, ‘Visual C++’ and ‘Visual Basic’. Further, the software may be in the form of a collection of separate programs, a program engine with a larger program or a region of the program engine. The software may also include modular programming in the form of object-oriented programming. The processing of input data by the processing machine may be in response to user commands, results of previous processing or a request made by another processing machine. The disclosure can also be implemented in all operating systems and platforms including, but not limited to, ‘Unix’, ‘DOS’, ‘Android’, ‘Symbian’, and ‘Linux’.

The programmable instructions can be stored and transmitted on a non-transitory computer-readable medium. The disclosure can also be embodied in a computer program product comprising a computer-readable medium, with the product capable of implementing the above methods and systems, or the numerous possible variations thereof.

While for purposes of simplicity of explanation, the illustrated methodologies are shown and described as a series of blocks/steps, it is to be appreciated that the methodologies are not limited by the order of the blocks, as some blocks can occur in different orders and/or concurrently with other blocks from those shown and described. Moreover, less than all the illustrated blocks may be required to implement an example methodology. Blocks may be combined or separated into multiple components. Furthermore, additional and/or alternative methodologies not illustrated in the blocks can be employed.

Various embodiments of the apparatus and method have been disclosed. It should be apparent, however, to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It will be appreciated by a person skilled in the art that the system, modules, and sub-modules have been illustrated and explained to serve as examples and should not be considered limiting in any manner. It will be appreciated that the variants of the above disclosed system elements, or modules and other features and functions, or alternatives thereof, may be combined to create many other different systems or applications.

Those skilled in the art will appreciate that any of the foregoing steps and/or system modules may be suitably replaced, reordered, or removed, and additional steps and/or system modules may be inserted, depending on the needs of a particular application, and that the systems of the foregoing embodiments may be implemented using a wide variety of suitable processes and system modules and is not limited to any particular computer hardware, software, middleware, firmware, microcode, etc.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art and also intended to be encompassed by the following claims.

What is claimed is:

1. A computer implemented method for determining real time bidding data corresponding to one or more advertisement campaigns targeting one or more users, the method comprising:
receiving a bid request for the one or more advertisement campaigns;
determining user interest data corresponding to the one or more users;
determining one or more bidding rules based on a first data set and a second data set, wherein the first data set comprises data corresponding to the one or more users and the second data set comprises data corresponding to the one or more advertisement campaigns; and
determining real time bidding data based on the user interest data and the one or more bidding rules.

2. The method of claim 1 further comprising optimizing the real time bidding data based on one or more key performance indicators of the one or more users and the one or more advertisement campaigns.

3. The method of claim 2 further comprising generating a bid response for the received bid request based on the optimized real time bidding data.

4. The method of claim 1, wherein the user interest data comprises at least one of a content category associated with at least one web page visited by the one or more users, keywords representing the user's interest corresponding to the one or more users, data associated with user's sharing activity and total number of clicks of the one or more users associated with the one or more advertisement campaigns.

5. The method of claim 1, wherein the first data set comprises at least one of a plurality of keywords describing users of the one or more advertisement campaigns, details associated with the users who have visited the one or more advertisement campaigns in the past but were not converted into buyers, user's behavioral response descriptors, details associated with user's performance towards the one or more advertisement campaigns, geo-location information of the users, demographic data of the users, transactional data of the users for buying one or more products or services and at least one content category associated both with the users and the one or more advertisement campaigns.

6. The method of claim 1, wherein the first data set corresponds to one or more of online or offline data.

7. The method of claim 1, wherein the second data set comprises at least one of a plurality of attributes describing an advertisement campaign performance, user response history, advertisement valuation and advertisement delivery goals.

8. The method of claim 1, wherein the second data set corresponds to one or more of online or offline data.

9. The method of claim 1, wherein the one or more bidding rules comprises one or more of a condition based rule, a limitation based rule, a decision based rule and a customized rule based on the real time bidding data.

10. The method of claim 1, wherein the real time bidding data comprises at least one of bidding price and delivery instructions for the one or more advertisement campaigns.

11. A system for optimizing real time bidding data corresponding to one or more advertisement campaigns for one or more users, the system comprises:
a user data extraction engine configured to determine user interest data corresponding to the one or more users;
a rules engine configured to determine one or more bidding rules based on a first data set and a second data set;
a real time bidding (RTB) engine configured to determine a real time bidding data based on the user interest data and the one or more bidding rules; and
a delivery and key performance indicator (KPI) optimization engine configured to optimize the real time bidding data.

12. The system of claim 11 further comprising a communication engine configured to receive a bid request from an exchange network.

13. The system of claim 12 wherein the RTB engine is further configured to generate a bid response in response to the bid request based on the optimized real time bidding data, wherein the bid response is utilized to select an advertisement campaign from the one or more advertisement campaigns.

14. The system of claim 11 wherein the user data extraction engine is further configured to generate the first data set comprising data corresponding to each of one or more users.

15. The system of claim 14, wherein the user data extraction engine is further configured to extract performance data of each of the one or more users on one or more advertisement campaigns.

16. The system of claim 11 further comprising an ad data aggregation engine configured to generate the second data set comprising data corresponding to each of the one or more advertisement campaigns.

17. A computer implemented method for generating a bid response in response to a bid request, the computer implemented method comprising:
receiving the bid request for an ad space on a web page to be displayed on a browser associated with a user;
determining user interest data corresponding to a plurality of users, the user being one of the plurality of users;
determining one or more bidding rules based on a first data set and a second data set;
determining a real time bidding data based on the user interest data and the one or more bidding rules;
optimizing the real time bidding data based on one or more parameters; and
generating the bid response based at least in part on the optimized real time bidding data.

18. The computer implemented method of claim 17, wherein the first data set comprises data corresponding to the plurality of users and the second data set comprises data corresponding to one or more advertisement campaigns.

19. The computer implemented method of claim 17, wherein the one or more parameters comprise key performance indicators of the plurality of users and one or more advertisement campaigns.

20. The computer implemented method of claim 19, wherein the key performance indicators comprise at least one of estimate of cost per 1000 views of the ad (CPM), conversion rate for visitors coming from each advertisement multiplied the by cost per visitor (Cost Per Acquisition or CPA), ratio of number of times an advertisement is clicked and number of times the advertisement is viewed (CTR), ratio of delivered conversions to delivered advertisements, multiplication of cost per ad impression (CPI) with number of ad impressions, ratio of CPI and CPA or percentage of leads generated via paid search (PPC).

21. A computer program product for use with a computer, the computer program product comprising instructions stored in a non-transitory computer usable medium having a computer readable program code embodied therein for generating a bid response in response to a bid request, the computer readable program code comprising a set of instructions for:
receiving a bid request for one or more advertisement campaigns;
determining user interest data corresponding to one or more users;
determining one or more bidding rules based on a first data set and a second data set, wherein the first data set comprises data corresponding to the one or more users and the second data set comprises data corresponding to the one or more advertisement campaigns;
determining real time bidding data based on the user interest data and the one or more bidding rules;
optimizing the real time bidding data based on one or more parameters; and
generating the bid response based at least in part on the optimized real time bidding data.
